(19) United States
(12) Patent Application Publication
(10) Pub. No.: US 2013/0072313 A1
(43) Pub. Date: Mar. 21, 2013

(54) TUNED PROPELLER SHAFT, VEHICLE CONTAINING THE SAME, AND METHOD OF REDUCING NOISE IN A VEHICLE DRIVELINE

(71) Applicant: Daniel R. Ryberg, Lake Orion, MI (US)

(72) Inventor: Daniel R. Ryberg, Lake Orion, MI (US)

(73) Assignee: CHRYSLER GROUP LLC, Auburn Hills, MI (US)

(21) Appl. No.: 13/238,384

(22) Filed: Sep. 21, 2011

(51) Int. Cl. F16C 3/00

(52) U.S. Cl. 464/183

(57) ABSTRACT

A driveshaft assembly that reduces noise created by a vehicle driveline. The driveshaft assembly includes a shaft having a first end section, a second end section, and a midsection positioned between the first end section and the second end section. The first end section and the second end section have a first diameter D1, the midsection has a second diameter D2, where D2<D1. The first end section and the second end section have a first thickness T1, the midsection has a second thickness T2, where T2>T1.

### FIELD

The present invention generally relates to a tuned propeller shaft that reduces noise created by a vehicle driveline, a vehicle containing the same, and a method of reducing noise in a vehicle driveline.

### BACKGROUND

Torque transmitting devices are used to transfer rotational power from one source to a rotatably driven mechanism. One example of a torque transmitting shaft is a driveshaft used in a powertrain of an automobile. The driveshaft transfers the rotational power from the engine of the automobile to a driven component such as the rear axle. Typically, a vehicle's driveshaft assembly includes a hollow cylindrical shaft having an end fitting secured to each end. One fitting is generally connected to the transmission while the other fitting is connected to the rear axle.

One problem encountered with driveshaft assemblies is that they tend to amplify undesirable noises during operation. All mechanical bodies have resonant frequencies that may cause objectionable noise levels when operated at certain rotational speeds. Resonant frequencies may vary based on factors such as the composition, size and shape of the object. One objective of vehicle design is to reduce the noise caused by the vibration of the driveshaft and provide a quieter ride.

Gear mesh error is an error in force transmission due to angular misalignment of gears as they engage. When the gears do not engage smoothly, vibration can be transmitted to the driveshaft. Because the gears and the driveshaft are strongly coupled, the resonant behavior of the driveline system can amplify the force transmission from the gears. As vehicle speed increases, the frequency of the gear mesh error correspondingly increases. As the gear mesh error frequency increases and passes through the same frequency range of the driveline system dynamics, amplification of the gear mesh force transmission occurs.

Many different mechanisms have been proposed to dissipate or absorb the vibrations emitted by the automobile's driveshaft during operation. Some of these mechanisms include torsional tuned absorbers and bending absorbers that are located inside or outside of the shaft. These mechanisms usually come with a cost and weight penalty.

### SUMMARY

In one form, the present disclosure provides a driveshaft assembly including a shaft having a first end section, a second end section, and a midsection positioned adjacent the first end section and the second end section. The first end section has a first diameter D1, the second end section has a second diameter D2, the midsection has a third diameter D3, the shaft has a first length L, and the midsection has a second length I. D1, D2, and D3 and the ratio of I to L are tuned to provide the driveshaft with desired characteristics.

In another form the present disclosure provides a vehicle having an engine and a driveline coupled to the engine. The driveline includes a shaft having a first end section, a second end section, and a midsection positioned between the first end section and the second end section. The first end section and the second end section have a first diameter D1, the midsection has a second diameter D2, the shaft has a first length L, and the midsection has a second length I. D1 and D2, and the ratio of I to L are tuned to provide the driveshaft with a desired torsional strength, minimal vibration characteristics, and to minimize generated noise.

In yet another form, the present disclosure provides a method of reducing vibration in a vehicle driveline and includes assembling a vehicle having an engine and a driveline coupled to the engine, and providing the driveline with a shaft having a first end section, a second end section, and a midsection positioned adjacent the first end section and the second end section, wherein the first end section and the second end section have a first diameter D1 and a first thickness T1, the midsection has a second diameter D2, the shaft has a first length L, and the midsection has a second length I and a second thickness T2. The method further includes tuning D1 and D2, T1 and T2, and the ratio of I to L to provide the driveshaft with a desired torsional strength, minimal vibration characteristics, and to minimize generated noise.

Further areas of applicability of the present disclosure will become apparent from the detailed description, drawings and claims provided hereinafter. It should be understood that the detailed description, including disclosed embodiments and drawings, are merely exemplary in nature, intended for purposes of illustration only, and are not intended to limit the scope of the invention, its application, or use. Thus, variations that do not depart from the gist of the invention are intended to be within the scope of the invention.

### BRIEF DESCRIPTION OF THE DRAWINGS

FIG. 1 is a top schematic view of a rear wheel vehicle having a driveshaft according to an aspect of the present invention;

FIG. 2 is a top schematic view of the second shaft 8 shown in FIG. 1; and

FIGS. 3-7 are graphs illustrating various results obtained by a comparison between a driveshaft constructed in accordance with the present teachings and that of a standard driveshaft.

### DETAILED DESCRIPTION

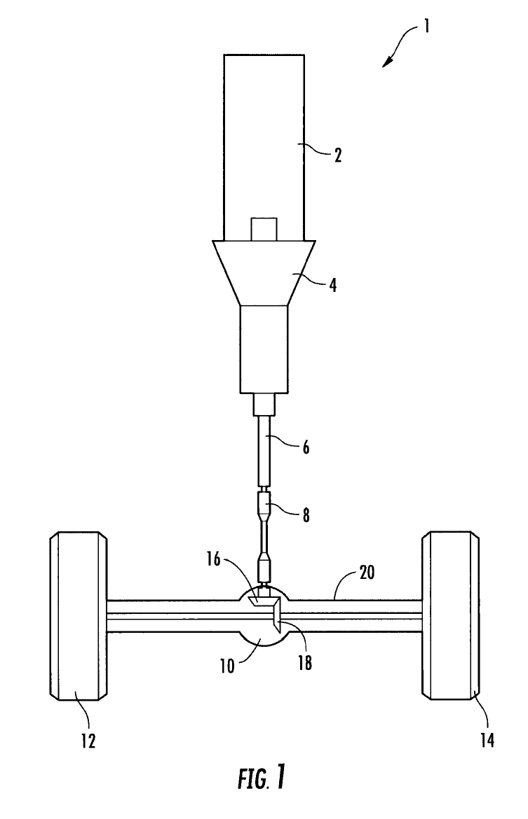

Referring now to the drawings in which like elements of the invention are identified with identical reference numerals throughout, FIG. 1 is a top schematic view of a chassis 1 and drivetrain of a rear wheel drive vehicle depicting a driveshaft according to the present teachings. Although FIG. 1 depicts the driveshaft with a rear wheel drive vehicle, a driveshaft according to the present teachings can also be incorporated into a 4 wheel drive or all wheel drive vehicle. In the particular embodiment of FIG. 1, the driveshaft according to the teachings of the invention is incorporated into a two-piece propeller shaft. Although not depicted in FIG. 1, the teachings of the invention can also be incorporated into a one-piece or three-piece driveshaft.

FIG. 1 also depicts some of the sources of vibration that are ultimately transmitted into the cabin through propagation in the driveline components. More specifically, the chassis 1 of FIG. 1 depicts an engine 2 coupled to an automatic or manual transmission 4. Rotational output from the transmission 4 may be input directly into a first shaft 6, and then a second shaft 8, and then into a differential 10. From the differential 10, power is divided to a left rear wheel 12 and a right rear wheel 14 via a pinion gear 16 and a ring gear 18 in a rear axle 20. It is through these driveline components that audible gear whine (vibration) is transmitted into the rear axle 20 through the pinion gear 16 and ring gear 18, and then into the vehicle cabin where it is perceived as audible whine. However, the driveshaft of the present teachings reduces the driveline angular velocity and the gear mesh force transmission. This, in turn, reduces the audible noise heard by the vehicle occupants.

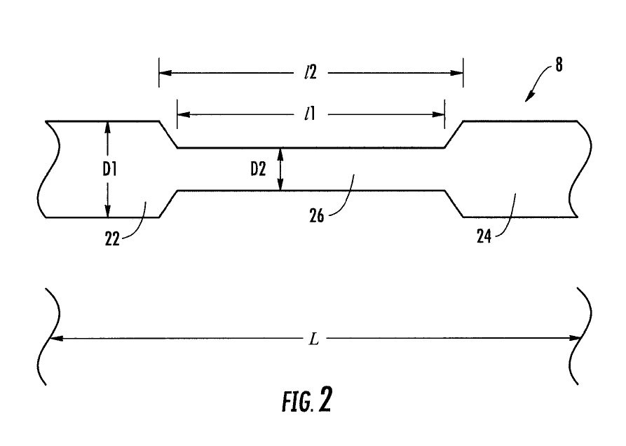

As shown more clearly in FIG. 2, the second shaft 8 of the driveshaft assembly according to the present teachings includes a first end section 22, a second end section 24, and a midsection 26 positioned between the first end section 22 and the second end section 24. The driveshaft assembly, including the first end section 22, second end section 24, and midsection 26, is formed in the shape of a tube with an at least partially hollow internal portion. The first end section 22 and the second end section 24 have an outer diameter D1 and a thickness T1, and the midsection 26 has an outer diameter D2 and a thickness T2. In one configuration of the driveshaft of the present teachings, D2≈0.6 D1 and T2>T1. In one configuration, D2 may be greater than or less than 0.6 D1. In one configuration, the first end section 22 may have a diameter D1, the second end section 24 may have a diameter D2, and the midsection 26 may have a diameter D3, where D1, D2, and D3 are all different and D1 and D2 are greater than D3. In one configuration, the first end section 22 may have a thickness T1, the second end section 24 may have a thickness T2, and the midsection 26 may have a thickness T3, where T1, T2, and T3 are all different and T1 and T2 are less than T3

When the diameter of the midsection of the shaft is within this range, the bending mode can be reduced and the torsional dynamic compliance can be tuned, as described in more detail below. The relative thicknesses of the end sections 22, 24 and the midsection 26 are factors for tailoring of the torque capacity of the driveshaft. FIG. 2 further illustrates that the second driveshaft 8 has an overall length of L, and the midsection 26 has a length I1 and an overall length of I2. The overall length I2 includes a length occupied by a transition piece between the length I1 and overall length I2. As non-limiting examples, the transition piece can be a separate reducer coupling that is welded between the midsection 26 and the end sections 22, 24, or the transition piece can be integral with the driveshaft if the driveshaft is constructed from a single piece of material. In the preferred configuration, the overall length I2 of the midsection 26 is approximately L/3. In one configuration, the length, diameter, and wall thickness of the first end section 22, second end section 24, and midsection 26 may be tuned to achieve desirable driveshaft characteristics. In one embodiment, the length, diameter, and wall thickness of the first end section 22, second end section 24, and midsection 26 may be tuned to provide the driveshaft with a desired torsional strength, minimal vibration characteristics, to minimize generated noise, or any combination of the three. In one embodiment, these characteristics are optimized for driveshaft RPM corresponding to vehicle speeds experienced during highway operation at between approximately 40 and 80 miles per hour (“mph”).

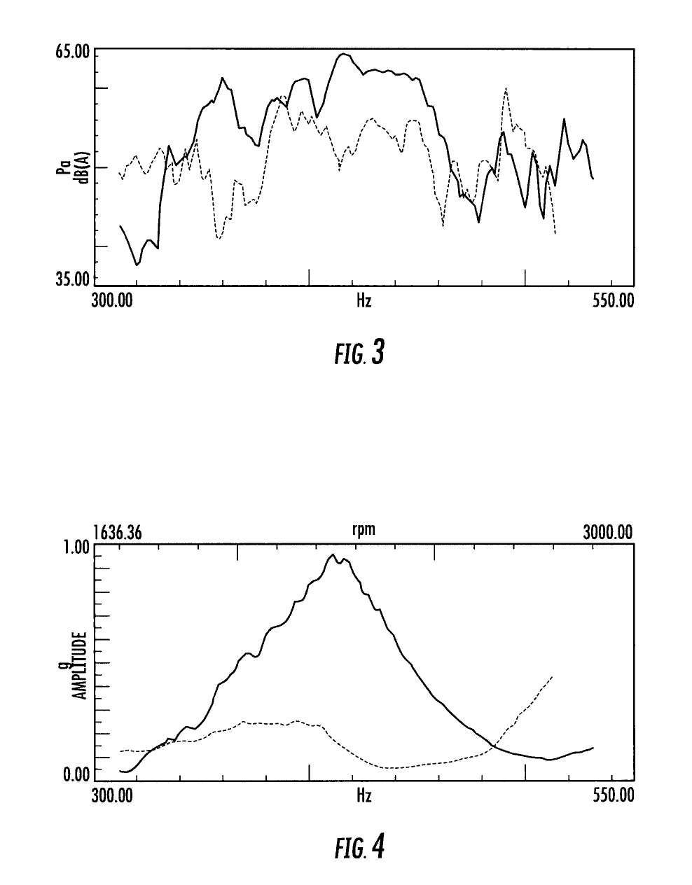

FIGS. 3-7 are graphs illustrating various results obtained by a comparison between a driveshaft constructed in accordance with the present teachings (shown in a dashed line) and that of a standard driveshaft (shown in a solid line). The standard driveshaft had a length of 540 mm, a diameter of 60 mm and a thickness of 1.8 mm. The driveshaft constructed in accordance with the present teachings had the following dimensions: D1=60 mm; D2=38 mm; T1=1.8 mm; T2=3.0 mm; L=540 mm (measurement of the shaft tube length, i.e., from friction weld to friction weld excluding the yolk at either end); I1=185 mm; and I2=210 mm.

In the graphs of FIGS. 3-6, a test vehicle was equipped with a V-8 engine and an 11th order gear, and the vehicle speed was approximately 60 mph with a driveshaft speed of approximately 2280 RPM. The 11th order refers to the number of gear teeth on the pinion gear within the rear carrier.

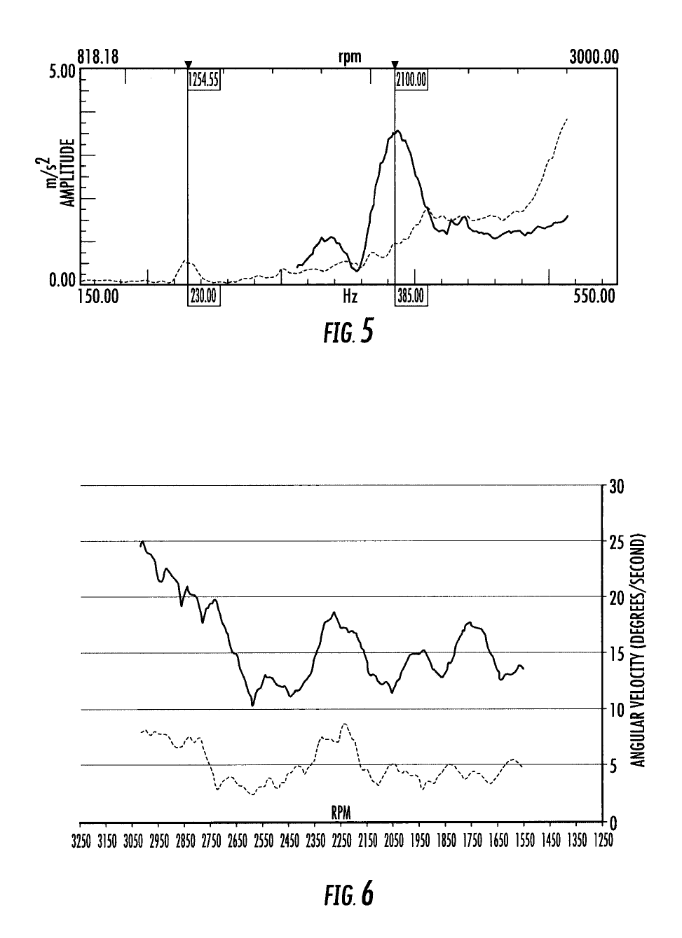

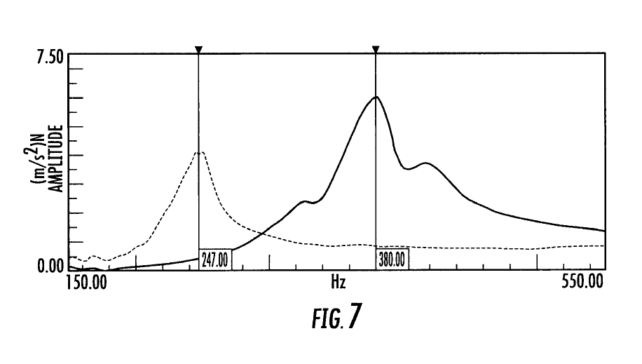

As shown in FIGS. 3-6, the driveshaft of the present teachings successfully reduces the cabin noise by as much as 10 dBA, reduces the vibration of the rear axle, reduces the angular velocity of the driveshaft (i.e., tunes the torsional compliance), and shifts the bending mode of the driveshaft in the mid-frequency range without the need for add-on components. More specifically, FIG. 3 illustrates the noise level reduction by as much as 10 dB(A) from use of a driveshaft in accordance with the present teachings at an interior passenger position within the vehicle cabin as compared to a standard driveshaft. With reference to FIG. 3, dB(A) refers to the use of a weighted sound filter that is weighted towards sounds within the range of human hearing. FIG. 4 illustrates the reduction in vibration in the vertical (Z) direction between a driveshaft in accordance with the present teachings and a standard driveshaft as measured on the differential 10. The RPM range depicted in FIG. 4 corresponds to rotational speeds of the driveshaft at highway operating speeds for the vehicle between 40 and 80 mph. FIG. 5 illustrates the reduction in vibration in the lateral (Y) direction between a driveshaft in accordance with the present teachings and a standard driveshaft as measured by an accelerometer on the differential 10. FIG. 6 illustrates the reduction in the angular velocity (i.e., torsional compliance) in the mid-frequency range between a driveshaft in accordance with the present teachings and a standard driveshaft as measured near the driveshaft coupling point to the axle of the test vehicle.

FIG. 7 illustrates the bending frequency shift based on an impact response while in a static condition. More specifically, FIG. 7 shows that the driveshaft in accordance with the present teachings has a frequency shift at the midsection thereof from approximately 380 Hz of the standard driveshaft to approximately 247 Hz. In addition, FIG. 7 shows that the driveshaft in accordance with the present teachings has an amplitude drop at the midsection thereof from approximately 6 (m/s²)/N of the standard driveshaft to approximately 4(m/s²)/N.

Thus, a driveshaft according to the invention can effectively assist in reducing vibrational noise from a vehicle driveshaft without the need for add-on pieces, such inertial rings.

What is claimed is:

1. A driveshaft assembly comprising:
a shaft having a first end section, a second end section, and a midsection positioned adjacent the first end section and the second end section,
wherein the first end section has a first diameter D1, the second end section has a second diameter D2, the midsection has a third diameter D3, the shaft has a first length L, and the midsection has a second length I, and
wherein D1, D2, and D3 and the ratio of I to L are tuned to provide the driveshaft with desired characteristics.

2. The shaft assembly according to claim 1, wherein D3≈0.6 D1 and D3≈0.6 D2.

3. The shaft assembly according to claim 1, wherein D1 and D2 are different.

4. The shaft assembly according to claim 1, wherein D1 and D2 and the ratio of I to L are tuned to provide the driveshaft with a desired torsional strength, minimal vibration characteristics, and to minimize generated noise at driveshaft rotational speeds corresponding to a vehicle speed of between approximately 40 and 80 miles per hour.

5. The shaft assembly according to claim 1, wherein the shaft has a length L, and a length of the midsection is L/3.

6. The shaft assembly according to claim 1, wherein the second diameter is sized so as to reduce a bending mode of the shaft.

7. The shaft assembly according to claim 1, wherein the midsection is sized so as to tune a torsional dynamic compliance of the shaft.

8. The shaft assembly according to claim 1, wherein the first end section and the second end section have a first thickness T1, the midsection has a second thickness T2, and T2>T1.

9. The shaft assembly according to claim 1, wherein the first end section has a first thickness T1, the second end section has a second thickness T2, the midsection has a third thickness T3, and T3>T1 and T3>T2.

10. A vehicle comprising:
an engine; and
a driveline coupled to the engine, the driveline including a shaft having a first end section, a second end section, and a midsection positioned between the first end section and the second end section,
wherein the first end section and the second end section have a first diameter D1, the midsection has a second diameter D2, the shaft has a first length L, and the midsection has a second length I, and
wherein D1 and D2, and the ratio of I to L are tuned to provide the driveshaft with a desired torsional strength, minimal vibration characteristics, and to minimize generated noise.

11. The vehicle according to claim 10, wherein the shaft has a length L, and a length of the midsection is L/3.

12. The vehicle according to claim 10, wherein the second diameter is sized so as to reduce a bending mode of the shaft.

13. The vehicle according to claim 10, wherein the midsection is sized so as to tune a torsional dynamic compliance of the shaft.

14. The vehicle according to claim 10, wherein the first end section and the second end section have a first thickness T1, the midsection has a second thickness T2, and T2>T1.

15. A method of reducing vibration in a vehicle driveline, the method comprising:
assembling a vehicle having an engine and a driveline coupled to the engine;
providing the driveline with a shaft having a first end section, a second end section, and a midsection positioned adjacent the first end section and the second end section,
wherein the first end section and the second end section have a first diameter D1 and a first thickness T1, the midsection has a second diameter D2, the shaft has a first length L, and the midsection has a second length I and a second thickness T2; and
tuning D1 and D2, T1 and T2, and the ratio of I to L to provide the driveshaft with a desired torsional strength, minimal vibration characteristics, and to minimize generated noise.

16. The method according to claim 15, wherein the shaft has a length L, and a length of the midsection is L/3.

17. The method according to claim 15, further comprising sizing the second diameter so as to reduce a bending mode of the shaft.

18. The method according to claim 15, further comprising sizing the midsection so as to tune a torsional dynamic compliance of the shaft.

19. The method according to claim 15, wherein T2>T1.

20. The shaft assembly according to claim 15, wherein D1 and D2, T1 and T2, and the ratio of I to L are tuned to provide the driveshaft with a desired torsional strength, minimal vibration characteristics, and to minimize generated noise at driveshaft rotational speeds corresponding to a vehicle speed of between approximately 40 and 80 miles per hour.
